(19) United States
(12) Patent Application Publication
(10) Pub. No.: US 2015/0057823 A1
(43) Pub. Date: Feb. 26, 2015

(54) CONTROL APPARATUS, CONTROL SYSTEM, AND CONTROL METHOD

(71) Applicant: KYOCERA CORPORATION, Kyoto (JP)

(72) Inventor: Taku Nakayama, Yamato-shi (JP)

(73) Assignee: KYOCERA CORPORATION, Kyoto (JP)

(21) Appl. No.: 14/388,439

(22) PCT Filed: Mar. 26, 2013
(86) PCT No.: PCT/JP2013/058748

§ 371 Date: Sep. 26, 2014

(30) Foreign Application Priority Data
Mar. 28, 2012 (JP) 2012-075218

(51) Int. Cl. H04L 12/28; G05B 19/418

(52) U.S. Cl. CPC H04L 12/2816; G05B 19/41855; G05B 2219/31115; G05B 2219/31233
USPC 700/295

(57) ABSTRACT

A HEMS (100) for controlling equipment connected to an in-house network (3), via the in-house network (3), monitors the in-house network (3). The HEMS (100) which, when detecting that new equipment is connected to the in-house network (3), causes the first communication unit to inquire the new equipment as to information related to the new equipment.

### TECHNICAL FIELD

The present invention relates to a control apparatus, a control system, and a control method, each of which controls equipment connected to a network provided at a power consumer's facility.

### BACKGROUND ART

In recent years, there has been a growing interest in energy saving, and an energy management system (EMS) for performing power management for each power consumer's facility has been noticed. A control apparatus for performing power management for each house is referred to as an in-house energy management system (HEMS).

Such control apparatus, via a network provided at a power consumer's facility, controls equipment connected to the network (for example, refer to Patent Literature 1 and Patent Literature 2).

### CITATION LIST

### Patent Literature

[PTL 1] Japanese Unexamined Patent Application Publication No. 2009-261159
[PTL 2] Japanese Unexamined Patent Application Publication No. 2009-259125

### SUMMARY OF INVENTION

However, in a case where new equipment is connected to a network, it is assumed that there may be a case in which a control apparatus does not have information used for control of the new equipment. In this case, there is a problem that the control cannot control the new equipment appropriately.

Accordingly, it is an object of the present invention to provide a control apparatus, a control system, and a control method, each of which is capable of appropriately controlling equipment connected to a network provided at a power consumer's facility.

In order to solve the problem described above, the present invention has the following characterizing features.

A characteristic of the present invention is summarized in that a control apparatus for controlling equipment connected to a network, via the network provided at a power consumer's facility, the control apparatus comprising: a first communication unit which performs communication via the network; and a control unit which, when detecting that new equipment is connected to the network, causes the first communication unit to inquire the new equipment as to information related to the new equipment.

The control apparatus, further comprising: a storage unit in which detailed information used for control is registered by the equipment connected to the network; and a second communication unit which performs communication via an external network provided outside of the consumer, wherein, in a case where the detailed information corresponding to the new equipment is not registered in the storage unit, based on a result of inquiry relative to the new equipment, the control unit causes the second communication unit to acquire detailed information corresponding to the new equipment via the external network.

The control unit registers in the storage unit the detailed information corresponding to the new equipment acquired via the external network and subsequently monitors operational features of the new equipment by control of the new equipment using the registered detailed information, and the control unit updates the registered detailed information, based on the monitored operational features.

The control unit uses the registered detailed information for control of the new equipment, when determining that the detailed information corresponding to the new equipment is already registered in the storage unit, based on a result of inquiry relative to the new equipment.

The detailed information includes at least one of a power consumption feature, a charging feature, a discharging feature, and a power generation feature, according to a use environment of a corresponding equipment.

The detailed information includes at least one of a power consumption feature, a charging feature, a discharging feature, and a power generation feature, according to an operation mode of a corresponding equipment.

The control apparatus, further comprising an output unit which outputs at least one of an image and a voice, wherein when controlling equipment by using the detailed information registered in the storage unit, the control unit monitors operational features of the equipment, and the control unit causes the output unit may be to output a warning message as to the equipment, based on a difference between operational features included in the detailed information used for control of the equipment and the monitored operational features.

the control unit monitors operational features of the equipment, when controlling equipment by using the detailed information registered in the storage unit and, the control unit causes the first communication unit or the second communication unit to transmit a warning message as to the equipment to a predetermined destination, on a basis of a difference between operational features included in the detailed information used for control of the equipment and the monitored operational features.

A characteristic of the present invention is summarized in that a control system for controlling equipment connected to a network via the network provided at a power consumer's facility, the control system comprising: a first communication unit which performs communication via the network; and a control unit which, when detecting that new equipment is connected to the network, causes the first communication unit to inquire the new equipment as to information related to the new equipment.

A characteristic of the present invention is summarized in that a control method for controlling equipment connected to a network via the network provided at a power consumer's facility, the control method comprising the steps of; monitoring the network; and inquiring new equipment as to information related to the new equipment, when detecting that the new equipment is connected to the network.

According to the present invention, there can be provided a control apparatus, a control system, and a control method, each of which is capable of appropriately controlling equipment connected to a network provided at a power consumer's facility.

### BRIEF DESCRIPTION OF DRAWINGS

FIG. 1 is a block diagram of a power control system.

FIG. 2 is a block diagram of HEMS.

FIG. 3 shows an example of equipment information registered in a storage unit of HEMS.

FIG. 4 is a flowchart of operation of HEMS

FIG. 5 is a view for explaining a specific example of operation of HEMS.

FIG. 6 is a sequence chart of the specific example of operation of HEMS.

FIG. 7 shows an example of detailed information in the specific example of operation of HEMS.

### DESCRIPTION OF EMBODIMENTS

Embodiments of a tire according to the present invention will be described with reference to the drawings. In the drawings according to the following embodiments, same or similar constituent elements are designated by same or similar reference numerals.

### (1) Entire System Configuration

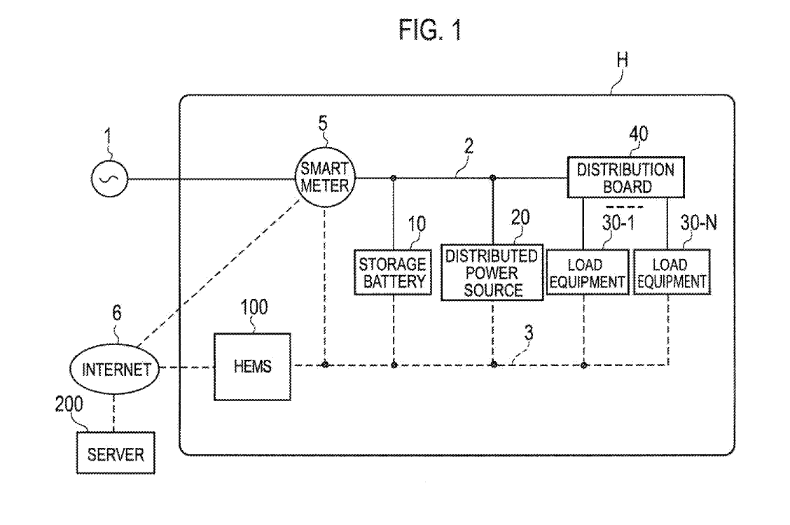

FIG. 1 is a block diagram of a power control system according to the present embodiment.

As shown in FIG. 1, the power control system according to the present embodiment has a grid power source 1 and a house H as a consumer that receives the power supply from the grid power source 1.

The house H includes: a power line 2 that transmits power between the house and the grid power source 1; a smart meter 5 and a distribution board 40 that are provided over the power line 2; a storage battery 10 connected to the power line 2; a distributed power source 20; a plurality of load equipment 30; and HEMS 100. The storage battery 10 may be in plurality, and the distributed power source 20 may be in plurality.

The smart meter 5, the storage battery 10, the distributed power source 20, the load equipment 20, and the HEMS 100 are connected to an in-house network 3. The in-house network 3 may be a wireless network by ZigBee (a registered trademark) or the like or may be a wired network by the Ethernet (a registered trademark) or the like. At least a part of the in-house network 3 may be shared with the power line 2 by power line communication (PLC). Hereinafter, the storage battery 10, the distributed power source 20, and the load equipment 30 are generally referred to as “equipment” as required.

The grid power source 1 is managed by an electric power company and supplies power to the house H.

The smart meter 5 is connected to the Internet 6. The smart meter 5 measures the quantity of power consumption of the house H, and can transmit a measurement result via the Internet 6 or can receive a variety of information via the Internet 6.

The storage battery 10 is charged by the power that is input via the power line 2. The storage battery 10 supplies power to the load equipment 30 via the power line 2 and the distribution board 40 by performing discharging.

The distributed power source 20 is a power generator that supplies power to the load equipment 30 and/or the storage battery 10 via the power line 2 and the distribution board 40. The distributed power source 20 may be a distributed power source, which is capable of controlling the quantity of power generation or may be a distributed power source which is incapable of controlling the quantity of power generation.

The distributed power source that is capable of controlling the quantity of power generation is a distributed power source which performs power generation by employing gas or the like, and includes a fuel cell such as SOFC (Solid Oxide Fuel Cell) or PEFC (Polymer Electrolyte Fuel Cell, and a gas turbine power generator or the like, for example.

On the other hand, a distributed power supply of such a type that is incapable of controlling the quantity of power generation is a distributed power source which performs power generation by employing a natural energy (a recyclable energy), and that includes a solar light electric power generator and a wind power electric power generator or the like, for example. Such distributed power source can provide a reverse power flow (so-called selling electricity) of generated power to the grid power source 1.

The load equipment 30 operates by consuming the power that is input via the distribution board 40. The load equipment 30 is a consumer electrical appliance (such as refrigerator, air conditioner, and illumination fixture) which is provided in the house H, for example.

The distribution board 40 distributes the power that is input via the power line 2, to a plurality of load equipment 30. Also, in a case where the distributed power source 20 is a distributed power source which performs power generation by employing natural energy (recyclable energy), the distribution board 40 may provide a reverse power flow of the power that is generated by the distributed power source 20, to the grid power source 1.

Each of the equipment includes a sensor for measuring itself operational features and a use environment. The operational features and the use environment will be described later. Also, each of the equipment includes a controller for operation in accordance with control from the HEMS 100. The controller can transmit a value of measurement of the sensor to the HEMS 100 via the in-house network 3.

The HEMS 100 manages the quantity of power consumption in the house H, and performs communication with equipment by employing a communication protocol such as ECHONET Lite or ZigBee (a registered trademark) to control the equipment. In the embodiment, the HELM 100 is equivalent to a control apparatus.

The HEMS 100 is connected to the Internet 6, and performs communication with the server 200 provided over the Internet 6. In the embodiment, the Internet 6 is equivalent to an outhouse network. The HEMS 100 may perform communication with the server 200 provided over the Internet 6 via the smart meter 5.

The server 200 accumulates and manages information related to equipment acquired from the HEMS 100. The server 200 may be a part of a community energy management system (CEMS) which performs power management by community management.

### (2) Configuration of HEMS

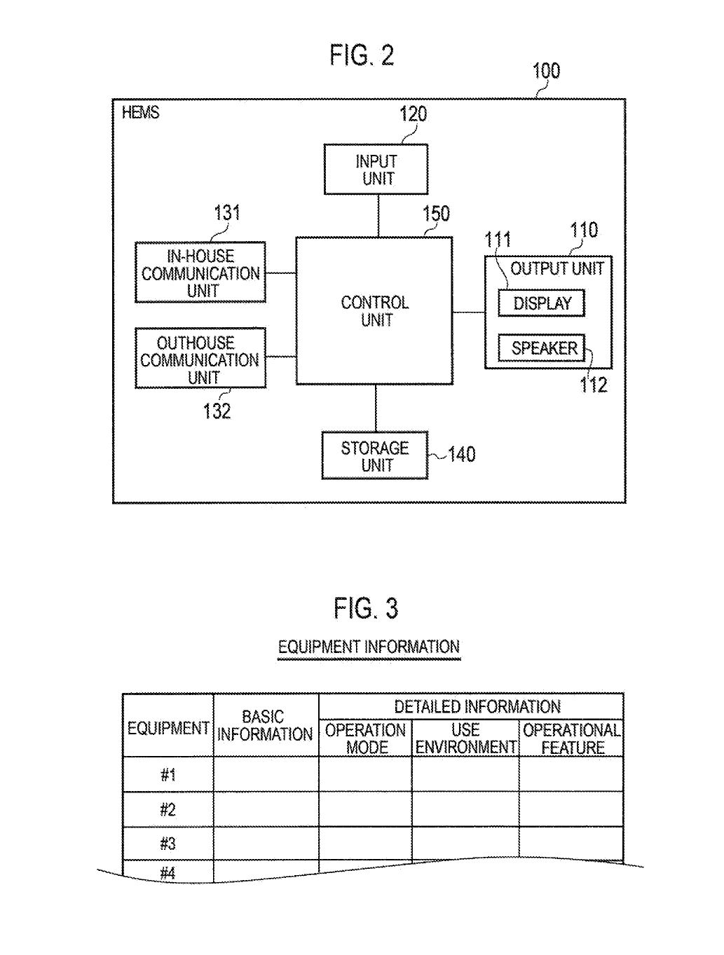

FIG. 2 is a block diagram of the HEMS 100.

As shown in FIG. 2, the HEMS 100 has an output unit 110, an input unit 120, an in-house communication unit 131, an outhouse communication unit 132, a storage unit 140, and a control unit 150.

The output unit 110 includes: a display 111 which performs image display under the control of the control unit 150; and a speaker 112 which performs voice output under the control of the control unit 150.

The input unit 120 receives an input from a user, and outputs the input contents to the control unit 150. The input unit 120, as a touch panel, may be integrated with the display 111.

The in-house communication unit 131 performs communication with equipment via the in-house network 3 by employing a communication protocol such as ECHONET Lite under the control of the control unit 150. The in-house communication unit 131 may be a ZigBee (a registered trademark) module for performing communication with the equipment. In the embodiment, the in-house communication unit 131 is equivalent to a first communication unit.

The outhouse communication unit 132 performs communication with a server 200 via the Internet 6 under the control of the control unit 150. In the embodiment, the outhouse communication unit 132 is equivalent to a second communication unit.

The storage unit 140 stores a variety of information used for the control exerted by the control unit 150. In the storage unit 140, for each of the equipment connected to the in-house network 3, equipment information related to the equipment is registered.

FIG. 3 shows an example of the equipment information registered in the storage unit 140.

As shown in FIG. 3, equipment information includes: “basic information” which is basic information related to equipment; and “detailed information” which is detailed information related to the equipment. The basic information is an item of information used to identify the equipment, and includes manufacturer, equipment type, equipment category, equipment model number, equipment manufacturing number or the like. Also, the basic information may include reference destination address information such as URL from which information of these equipment can be obtained. The detailed information is an item of information used for control of the equipment, and includes information related to specification such as permissible operation modes and permissible values. Also, the detailed information may include operational features for each operation mode.

The detailed information includes: “operation modes” permissible for the equipment; “use environment” for the equipment; and “operational features” for the equipment in a case where the operation modes and the use environment are applied.

The operation modes are units for the HEMS 100 (the control unit 150) to perform control for equipment. The operational features of equipment include a variety of parameters and thus the HEMS 100 manages a plurality of parameters in all in units of operation modes, and performs control of switching one operation mode to another operation mode, whereby a processing load can be restrained.

The use environment is an environment in which equipment is used (such as ambient environment). For example, ambient temperature, humidity, climate, and season or the like are equivalent to the use environment. As to an air conditioner as the load equipment 30, a space of a room in which the air conditional is to be installed is also included in the use environment.

The operational features are features (parameters) of operation of equipment in a corresponding operation mode and use environment. As to the storage battery 10, a charging feature and a discharging feature or the like are equivalent to the operational features. As to the distributed power source 20, a power generation feature or the like is equivalent to one of the operational features. As to the load equipment 30, a power consumption feature or the like is equivalent to one of the operational features.

The control unit 150 controls a variety of equipment of the HEMS 100. The control unit 150 performs control of equipment by using the detailed information registered in the storage unit 140. For example, the control unit 150 determines an operation mode, based on the detailed information for each of equipment, and supplies an operational instruction so as to perform operation in the determined operation mode to thereby control the equipment. For example, the control unit 150 controls equipment so as to decrease the quantity of power consumption in the house H (energy saving optimization control).

However, in a case where new equipment is connected to the in-house network 3, equipment information (detailed information) corresponding to the equipment is not registered in the storage unit 140 and thus control for the new equipment cannot be performed. Accordingly, in the embodiment, the control unit 150 performs the following control.

First, the control unit 150 controls the in-house communication unit 131 so as to monitor the in-house network 3. For example, in a case where a conforming communication protocol of the in-house communication unit 131 is SEP 2.0 of the ZigBee system or the like, for example, the control unit 150 controls the in-house communication unit 131 so as to broadcast an instruction in such a manner that only new equipment returns a response to the in-house network 3 at predetermined time intervals. Alternatively, in a case where a conforming communication system of the in-hose communication unit 131 is the ECHONET Lite system or the like, information to notify that new equipment takes part in the in-house network is voluntarily broadcast to the in-house network 3, and the in-house communication unit 131 receives the information to thereby detect that the new equipment is connected to the in-house network 3.

The control unit 150 controls the in-house communication unit 131 so as to inquire the new equipment as to information related to the new equipment, when detecting that the new equipment is connected to the in-house network 3.

In the embodiment, the control unit 150 controls the in-house communication unit 131 so as to make inquiry as to basic information of the new equipment as information related to the new equipment. In addition to the basic information, the control unit 150 may control the in-house communication unit 131 so as to make inquiry as to a part of detailed information (for example, use environment). Also, the control unit 150 may cause the output unit 110 to output an input request made by a user, as to information that cannot be acquired from a sensor of equipment (for example, a space of a room in which an air conditioner is installed).

Second, when determining that detailed information corresponding to new equipment is not registered in the storage unit 140, based on a result of inquiry to the new equipment (that is, basic information of the new equipment), the control unit 150 controls the outhouse communication unit 132 so as to acquire the detailed information corresponding to the new equipment, via the Internet 6. For example, the control unit 150 acquires operational features for each operation mode of the new equipment from the server 200.

Third, the control unit 150 registers in the storage unit 140 the detailed information corresponding to the new equipment acquired via the Internet 6. The control unit 150 controls the new equipment by using the detailed information registered in the storage unit 140. Then, the control unit 150 monitors the operational features of the new equipment when this control is performed. In detail, the control unit 150 registers an operation mode of the new equipment and then temporarily registers operational features for each operation mode, based on the detailed information. Next, the control unit 150 controls the new equipment for each of the registered operation modes, and monitors operational features for each operation mode.

Fourth, the control unit 150 updates the registered detailed information, based on the monitored operational features. The operational features included in the detailed information acquired via the Internet 6 are theoretical operational features, and does not conform to an actual use environment, and thus, such theoretical operational features are modified by way of operation (that is, temporary operation) under the actual use environment. On the other hand, when determining that the detailed information corresponding to the new equipment is already registered, based on a result of inquiry relative to the new equipment, the control unit 150 uses the registered detailed information for control of the new equipment.

By way of the first to fourth controls, the control in each operation mode for the new equipment is possible. Then, the control unit 150 controls each of equipment by using the registered detailed information.

In the embodiment, the control unit 150 also uses the detailed information for diagnosis of equipment as well as for control of equipment.

The control unit 150 compares operational features at the time of initial connection (initial setup) of equipment and the subsequent operational features to thereby specify degradation of features and an occurrence of a failure due to a degradation with the elapse of time of the equipment and then notify the fact to a user or the like. Thus, the precision of diagnosis can be enhanced by monitoring and comparing the operational features for each operation mode.

For example, when controlling equipment by using the detailed information registered in the storage unit 140, the control unit 150 monitors the operational features of the equipment. Then, the control unit 150 controls the output unit 110 so as to output a warning message as to the equipment, based on a difference between the operational features included in the detailed information used for the control and the monitored operational features. The warning message is an image or a voice for prompting replacement or repair of the equipment. The image may include a character sting.

Alternatively, the control unit 150 controls the in-house communication unit 131 or the outhouse communication unit 132 to transmit the warning message as to the equipment to a predetermined destination, based on the difference between the operational features included in the detailed information used for the control and the monitored operational features. The predetermined destination may be a user's communication terminal or may be a manufacturer's or repairer's communication terminal.

### (3) Operation of HEMS

Next, an operation of the HEMS 100 will be described.

### (3.1) Flow of Operation

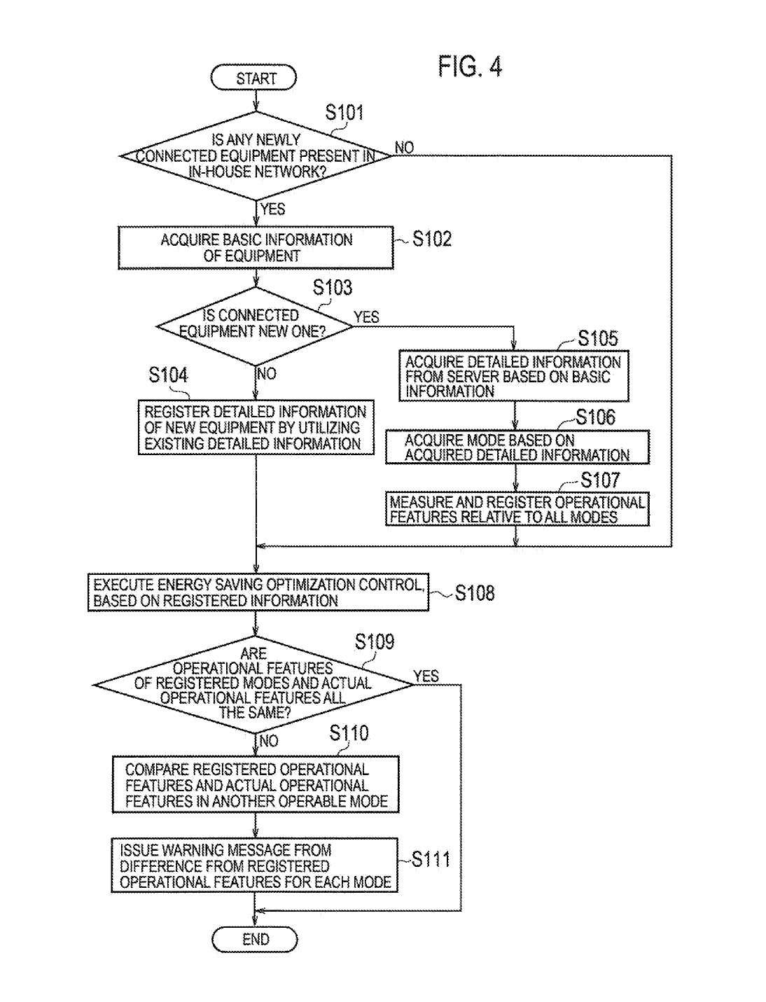

FIG. 4 is a flowchart of operation of the HEMS 100.

As shown in FIG. 2, in step S101, the control unit 150 checks whether or not a newly connected equipment (new equipment) is present in the in-house network 3. In a case where the new equipment is present (step S101; Yes), the process proceeds to step S102, and in a case where the new equipment is not present (step S101; No), the process proceeds to step S108.

In step S102, the control unit 150 controls the in-house communication unit 131 to make inquiry as to basic information of the new equipment. As a result of the inquiry, the in-house communication unit 131 receives the basic information of the new equipment and then the control unit 150 acquires the basic information. Here, the control unit 150 may acquire detailed information in addition to the basic information of the new equipment.

In step S103, the control unit 150 checks whether or not the basic information acquired in step S102 is already registered in the storage unit 140. In a case where the information is already registered (step S103; No), the process proceeds to step S104, and in a case where the information is not registered (step S103; Yes), the process proceeds to step S105.

Here, the case in which the information is already registered denotes a case of carrying an installed equipment out of the house, a case of reconnection after temporarily disconnection from the in-house network 3 such as a case of power interruption, or alternatively, a case of connecting to the in-house network 3 equipment of a same type as that of equipment that has been installed so far.

In step S104, the control unit 150 acquires from the storage unit 140 the detailed information corresponding to the basic information that is acquired in step S102, and then, by using the above detailed information, this control unit registers the detailed information corresponding to the new equipment in the storage unit 140. Afterwards, the process proceeds to step S108.

On the other hand, in step S105, the control unit 150 controls the outhouse communication unit 132 so as to inquire the server 200 over the Internet 6 as to the detailed information corresponding to the basic information by using the basic information acquired in step S102. As a result of the inquiry, the outhouse communication unit 132 receives the detailed information of the new equipment and then the control unit 150 acquires the detailed information. If URL as a reference destination is described as basic information, a user may inquire the server 200 by using the basic information acquired by accessing the URL.

In step S106, the control unit 150 registers the operation modes corresponding to the new equipment in the storage unit 140 and then temporarily registers operational features for each operation mode, based on the detailed information acquired in step S105.

In step S107, the control unit 150 monitors operational features of new equipment and then registers the monitored operational features in the storage unit 140, when controlling (temporarily driving) the new equipment for each operation mode registered in step S106.

In step S108, the control unit 150 executes energy saving optimization control, based on the detailed information registered in storage unit 140. In detail, this control unit performs switching control of operation mode of each of equipment so as to decrease the quantity of power consumption in the house H.

In step S109, when controlling equipment by using the detailed information registered in the storage unit 140, the control unit 140 monitors the operational features of the equipment. Then, the control unit 150 checks whether or not the operational features included in the detailed information used for the control and the monitored operational features are all the same. In a case where they are different (step S109; No), the process proceeds to step S110. Here, if a difference between the operational features included in the detailed information and the monitored operational features are within the range of a preset threshold value, it may be regarded to be the “same”.

In step S110, the control unit 150 switches to an operation mode other than that in step S109 and then monitors the operational features of the equipment. Then, the control unit 150 compares the operational features included in the detailed information used for the control and the monitored operational features. Step S110 is an inspection process for enhancing precision of diagnosis. Inspection is performed as to all operation modes, and a faulty site may also be estimated based on a combination of inspection results for each operation mode. For example, the operation characteristics included in detailed information and the monitored operational characteristics are compared, and in a case where any dissociation outside the preset threshold value arises, it may be estimated as a failure. Alternatively, in the operational features, the time expected when the process transfers from a state to another state and the actually monitored time are compared with each other and then a degree of dissociation and the threshold value are compared with each other, whereby estimation of a failure is possible.

In step S111, the control unit 150 issues a warning message as to the equipment. For example, the control unit 150 controls the output unit 110 so as to output the warning message or controls the in-house communication unit 131 or the outhouse communication unit 132 so as to transmit the warning message to a predetermined destination.

### (3.2) Specific Example

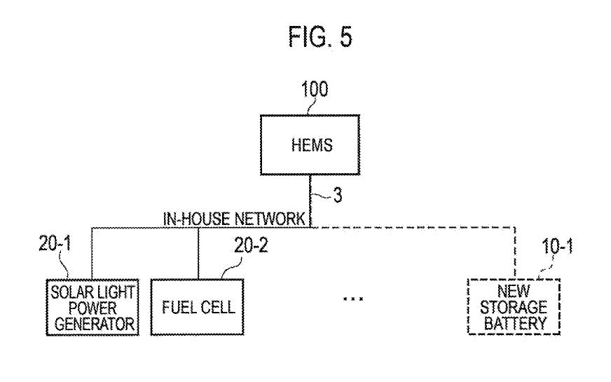

Next, a specific example of operation of the HEMS 100 will be described. FIG. 5 is a view for explaining a specific example of the operation of the HEMS 100.

As shown in FIG. 5, this specific example assumes a case in which a storage battery 10-1 is newly connected to the in-house network 3 under a circumstance that a solar light power generator 20-1 and a fuel battery 20-2 as a distributed power source 20 are connected to the in-house network 3. The storage battery 10-1 is assumed as equipment which is not registered in the HEMS 100.

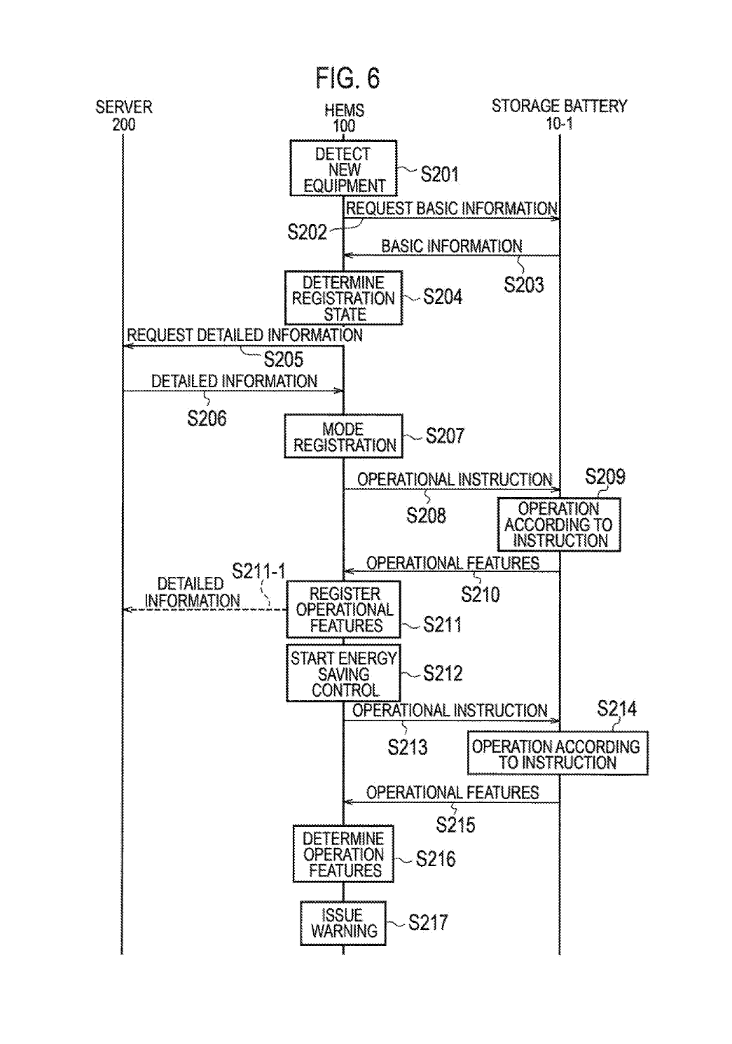

FIG. 6 is a sequence chart of this specific example.

As shown in FIG. 6, in step S201, the HEMS 100 monitors the in-house network 3 and then detects the storage battery 10-1 that is newly connected to the in-house network 3.

In step S202, the HEMS 100 transmits a basic information request for requesting transmission of basic information to the storage battery 10-1 via the in-house network 3.

In step S203, the storage battery 10-1 reads out basic information registered in itself, in response to the basic information request received from the HEMS 100, and then, transmits the readout basic information to the HEMS 100 via the in-house network 3.

In step S204, the HEMS 100 checks whether or not the basic information received from the storage battery 10-1 is already registered. Here, a description will be proceeded assuming that the basic information is not registered.

In step S205, the HEMS 100 transmits to the server 200 via the internet 6 the detailed information request for requesting transmission of the detailed information corresponding to the basic information that is received from the storage battery 10-1. The detailed information request includes the basic information received from the storage battery 10-1.

In step S206, the server 200 reads out the detailed information corresponding to the basic information included in the detailed information request, in response to the detailed information request received from the HEMS 100, and then, transmits the readout detailed information to the HEMS 100 via the Internet 6.

In step S207, the HEMS 100 registers an operation mode corresponding to the storage battery 10-1 and then temporarily registers operational features for each operation mode, based on the detailed information received from the server 200.

In step S208, the HEMS 100 transmits an operational instruction for controlling the storage battery 10-1 to the storage battery 10-1 via the in-house network 3 for each of the operation modes registered in step S207.

In step S209, the storage battery 10-1 performs operation (temporary operation) in accordance with the operational instruction received from the HEMS 100.

In step S210, the storage battery 10-1 measures operational features for each temporary operation and then transmits the measured operational features to the HEMS 100 via the in-house network 3.

In step S211, the HEMS 100 registers the operational features obtained from the storage battery 10-1 for each operation mode. Here, the HEMS 100 may transmit (that is, feedback) the detailed information by way of temporary operation from step S208 to step S211, to the server 200 via the Internet 6.

In step S212, the HEMS 100 executes energy saving optimization control, based on the detailed information that is already registered.

In step S213, the HEMS 100 transmits an operational instruction for controlling the storage battery 10-1 to the storage battery 10-1 via the in-house network 3 for the sake of energy saving optimization control.

In step S214, the storage battery 10-1 performs operation in accordance with the operational instruction received from the HEMS 100.

In step S215, the storage battery 10-1 measures the operational features by operation according to the operational instruction received from the HEMS 100 and then transmits the measured features to the HEMS 100 via the in-house network 3.

In step S216, the HEMS 100 checks whether or not the operational features included in the detailed information used for control of the storage battery 10-1 and the monitored operational features are all the same. Here, a description will be proceeded assuming that they are different. However, if the difference mentioned herein is within the range of tolerance, it may be regarded as the “same”.

In step S217, the HEMS 100 issues a waning message as to the storage battery 10-1. For example, the HEMS 100 outputs the warning message by image or voice. Alternatively, the HEMS 100 transmits the warning message to a predetermined destination.

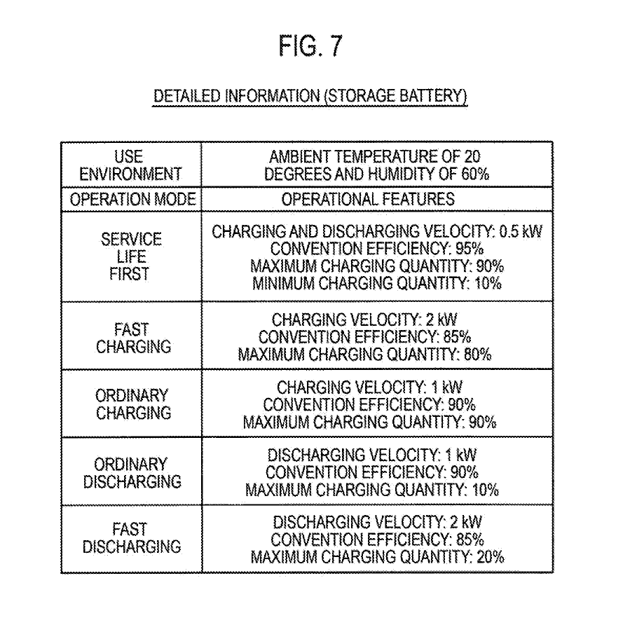

FIG. 7 shows a specific example of the detailed information corresponding to the storage battery 10-1. In this specific example, a use environment is “ambient temperature of 20 degrees and humidity of 60%”.

As shown in FIG. 7, the detailed information corresponding to the storage battery 10-1 includes, as operation modes, “service life first”, “fast charging”, “ordinary charging”, “ordinary discharging” and “fast discharging”. The operational features relative to “service life first” are charging and discharging velocity: 0.5 kW, conversion efficiency: 95%, maximum charging quantity: 90%, minimum charging quantity: 10%. Thus, the operational features as to each operation mode are registered.

In a case where diagnosis of the storage battery 10-1 is performed based on such detailed information, the HEMS 100 controls the storage battery 10-1 under the use environment of ambient temperature of 20 degrees and humidity of 60%, for example, in the operation mode “fast charging”, and then, monitors the operational features at that juncture. Afterwards, the HEMS 100 compares the registered operational features (charging velocity: 2 kW, conversion efficiency: 85%, maximum charging quantity: 80%) and the monitored operational features. For example, in a case where the monitored charging velocity is lower than the registered value, the HEMS 100 issues a warning message indicating the fact.

While a description has been given herein by diagnosis relative to the storage battery 10-1, a similar diagnosis is also possible relative to the solar light power generator 20-1, for example.

In this case, the HEMS 100 compares the operational features (for example, a power generation feature) included in the detailed information and the monitored features for each use environment (for example, climate and time intervals) included in the detailed information corresponding to the solar light power generator 20-1 and then determines a difference. In this manner, a diagnosis is performed to an extent such that the power generation feature monitored in sunny day and early in the morning is degraded more significantly than the registered power generation feature, and a warning message indicating the fact can be issued.

### (4) Summary of Embodiments

As has been described above, via the in-house network 3, when detecting that new equipment is connected to the in-house network 3, the HEMS 100 that controls equipment connected to the in-house network 3 makes inquiry as to basic information of the new equipment. In this manner, the HEMS 100 can acquire the basic information of the new equipment without any user intervention, and thus, based on the basic information, detailed information used for control of the new equipment can be automatically acquired.

In the embodiment, when determining that detailed information corresponding to new equipment is not registered, based on a result of inquiry as to the new equipment, the HEMS 100 acquires the detailed information corresponding to the new equipment via the Internet 6. In this manner, the HEMS 100 automatically acquires the detailed information used for control of the new equipment and then can use the acquired information for control of the equipment.

In the embodiment, the HEMS 100 registers detailed information acquired via the Internet 6 and then monitors operational features of new equipment at the time of controlling the new equipment by using the registered detailed information. Then, the HEMS 100 updates the registered detailed information, based on the monitored operational features. In this manner, the HEMS 100 can improve the precision of control because the detailed information (operational features) conforming to an actual use environment can be used for control of equipment.

In the embodiment, when determining that detailed information corresponding to new equipment is already registered, based on a result of inquiry as to the new equipment, the HEMS 100 uses the registered detailed information for control of the new equipment. Thus, in a case where the equipment having registered the detailed information is connected to the in-house network 3, an unrequired access to the server 200 can be avoided by using the detailed information.

In the embodiment, the detailed information includes at least one of a power consumption feature, a charging feature, a discharging feature, and a power generation feature, according to a use environment of a corresponding equipment. Thus, by grouping these operational features for each use environment and then managing and using the grouped operational features, the HEMS 100 can make control efficient in comparison with a case of individually managing and using the respective operational features.

In the embodiment, the detailed information includes at least one of a power consumption feature, a charging feature, a discharging feature, and a power generation feature, according to an operation mode of a corresponding equipment. Thus, by grouping these operational features for each operation mode and then managing and using the grouped operational features, the HEMS 100 can make control efficient in comparison with a case of individually managing and using the respective operational features.

In the embodiment, when controlling equipment by using the detailed information registered in the storage unit 140, the HEMS 100 monitors operational features of the equipment. Then, the HEMS 100 outputs a warning message as to the equipment, based on a difference between the operational features included in the detailed information used for the control and the monitored operational features. Thus, equipment is not only controlled by using the detailed information, but also the equipment is diagnosed and then a failure of the equipment can be notified to a user. Alternatively, by notifying the failure of the equipment to the outside, an operation such as arranging for repair of the equipment is also possible.

### (5) Other Embodiments

It is not to be understood that the statements and drawings forming a part of this disclosure limits the present invention. From this disclosure, a variety of substitute embodiments, examples, and operational technologies would have been self-evident to one skilled in the art.

While the foregoing embodiment described the HEMS 100 that is a control apparatus for performing power management by house, there may be BEMS targeted for building, FEMS targeted for factory, or SEMS targeted for shop or the like.

Also, in the foregoing embodiment, the server 200 may perform a part of the process that was described as being performed by the HEMS 100. For example, the server 200 compares the operational features included in the detailed information accumulated by itself and the operational features monitored by the HEMS 100 and then may perform selection of an operation mode of equipment and diagnosis of equipment.

Also, in a case where operational features of new equipment could not be acquired via the Internet 6, the control unit 150 acquires operational features for each operation mode by way of temporary operation of equipment and then may feedback the acquired operational features to the server 200.

Thus, it is a matter of course that the present invention includes a variety of embodiments or the like that are not described herein. Also, the foregoing embodiments and modification examples can be combined. Therefore, the technical scope of the present invention is defined only by specific matters of the invention according to the scope of claim that is reasonable from the foregoing description.

It is noted that the entire contents of Japanese Patent Application No. 2012-075218 (filed on Mar. 28, 2012) are incorporated in the present application by reference.

### INDUSTRIAL APPLICABILITY

According to the present invention, there can be provided a control apparatus, a control system, and a control method, each of which is capable of appropriately controlling equipment connected to a network provided at a power consumer's facility.

1. A control apparatus for controlling equipment connected to a network, via the network provided at a power consumer's facility, the control apparatus comprising:
a first communication unit which performs communication via the network; and
a control unit which, when detecting that new equipment is connected to the network, causes the first communication unit to inquire the new equipment as to information related to the new equipment.

2. The control apparatus according to claim 1, further comprising:
a storage unit in which detailed information used for control is registered by the equipment connected to the network; and
a second communication unit which performs communication via an external network provided outside of the consumer, wherein
in a case where the detailed information corresponding to the new equipment is not registered in the storage unit, based on a result of inquiry relative to the new equipment, the control unit causes the second communication unit to acquire detailed information corresponding to the new equipment via the external network.

3. The control apparatus according to claim 2, wherein
the control unit registers in the storage unit the detailed information corresponding to the new equipment acquired via the external network and subsequently monitors operational features of the new equipment by control of the new equipment using the registered detailed information, and
the control unit updates the registered detailed information, based on the monitored operational features.

4. The control apparatus according to claim 2, wherein
the control unit uses the registered detailed information for control of the new equipment, when determining that the detailed information corresponding to the new equipment is already registered in the storage unit, based on a result of inquiry relative to the new equipment.

5. The control apparatus according to claim 2, wherein
the detailed information includes at least one of a power consumption feature, a charging feature, a discharging feature, and a power generation feature, according to a use environment of a corresponding equipment.

6. The control apparatus according to claim 2, wherein
the detailed information includes at least one of a power consumption feature, a charging feature, a discharging feature, and a power generation feature, according to an operation mode of a corresponding equipment.

7. The control apparatus according to claim 2, further comprising an output unit which outputs at least one of an image and a voice, wherein
when controlling equipment by using the detailed information registered in the storage unit, the control unit monitors operational features of the equipment, and
the control unit causes the output unit to output a warning message as to the equipment, based on a difference between operational features included in the detailed information used for control of the equipment and the monitored operational features.

8. The control apparatus according to claim 2, wherein
when controlling equipment by using the detailed information registered in the storage unit, the control unit monitors operational features of the equipment, and
the control unit causes the first communication unit or the second communication unit to transmit a warning message as to the equipment to a predetermined destination, on a basis of a difference between operational features included in the detailed information used for control of the equipment and the monitored operational features.

9. A control system for controlling equipment connected to a network via the network provided at a power consumer's facility, the control system comprising:
a first communication unit which performs communication via the network; and
a control unit which, when detecting that new equipment is connected to the network, causes the first communication unit to inquire the new equipment as to information related to the new equipment.

10. A control method for controlling equipment connected to a network via the network provided at a power consumer's facility, the control method comprising the steps of:
monitoring the network; and
inquiring new equipment as to information related to the new equipment, when detecting that the new equipment is connected to the network.
